(19) United States
(12) Patent Application Publication
(10) Pub. No.: US 2025/0376364 A1
(43) Pub. Date: Dec. 11, 2025

(54) AERIAL LIFT INTERLOCKED WITH FALL-PROTECTION SAFETY APPARATUS

(71) Applicant: 3M INNOVATIVE PROPERTIES COMPANY, St. Paul, MN (US)

(72) Inventors: Jonathan J. Lepp, Eagan, MN (US); Christopher J. Reineke, Forest City, IA (US); Kristin M. Mikes, Forest City, IA (US); Donaldo J. Medeiros, Oakville (CA); Jeffrey T. Keacher, Denver, CO (US); Aline H. Hinkle, Woodbury, MN (US); Christopher M. Higgins, Forest City, IA (US); Heidi A. Lopez-Hidalgo, South St. Paul, MN (US); Tyler B. Henn, Buffalo Center, IA (US); Lauren K. Carlson, St. Paul, MN (US); Michael T. Weiss, Hastings, MN (US)

(21) Appl. No.: 19/311,662

(22) Filed: Aug. 27, 2025

Related U.S. Application Data
(63) Continuation of application No. 18/569,273, filed on Dec. 12, 2023, now Pat. No. 12,428,278.
(60) Provisional application No. 63/217,806, filed on Jul. 2, 2021.
(60) Provisional application No. 63/232,388, filed on Aug. 12, 2021.

(51) Int. Cl. B66F 17/00; A62B 35/00; A62B 35/04; B66F 11/04

(52) U.S. Cl. CPC B66F 17/003; A62B 35/0037; A62B 35/0068; A62B 35/0075; A62B 35/04; B66F 11/046; B66F 17/006; A62B 35/0093

(57) ABSTRACT

An aerial lift that is interlocked with a fall-protection apparatus and is further interlocked with at least one additional safety apparatus. The serial lift is equipped with a monitoring system that is configured to detect whether a connector of a safety line of the fall-protection apparatus appears to be connected to a safety harness of a user of the aerial lift.

### BACKGROUND

Aerial lifts are widely used for a variety of applications. In particular, so-called order pickers are motorized aerial lifts that are widely used for materials handling to pick items from vertical stacks, from shelves of various heights, and so on.

### SUMMARY

In broad summary, herein is disclosed an aerial lift that is interlocked with a fall-protection apparatus and is further interlocked with at least one additional safety apparatus. The aerial lift is equipped with a monitoring system that is configured to detect whether a connector of a safety line of the fall-protection apparatus appears to be connected to a safety harness of a user of the aerial lift. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side perspective view of an aerial lift, in exemplary, generic representation, the aerial lift being an order picker equipped with a monitored fall-protection apparatus, also shown in exemplary generic representation.

FIG. 2 is a side perspective view of another exemplary order picker, shown in a vertically elevated configuration.

FIG. 3 is a front view of an exemplary fall-protection apparatus suitable for use in a fall-protection system of an aerial lift.

FIG. 4 is a rear view of a fall-protection harness suitable for use in a fall-protection system of an aerial lift.

Like reference numbers in the various figures indicate like elements. Some elements may be present in identical or equivalent multiples; in such cases only one or more representative elements may be designated by a reference number but it will be understood that such reference numbers apply to all such identical elements. All figures and drawings in this document are not to scale and are chosen for the purpose of generically illustrating representative embodiments of the invention. In particular the dimensions of the various components are depicted in illustrative terms only, and no relationship between the dimensions of the various components should be inferred from the drawings, unless so indicated.

Although terms such as “first” and “second” may be used in this disclosure, it should be understood that those terms are used in their relative sense only unless otherwise noted. Furthermore, such terms do not invoke any temporal order unless specifically noted. Terms such as vertical, upward and downward, above and below, and so on, have their ordinary meaning with respect to the Earth's gravity. The horizontal direction likewise has its ordinary meaning as any direction perpendicular to the vertical direction.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter.

### DETAILED DESCRIPTION

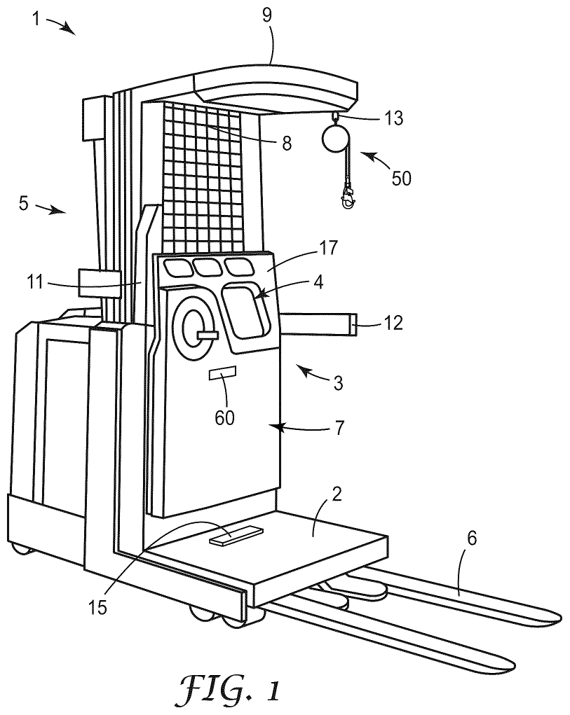

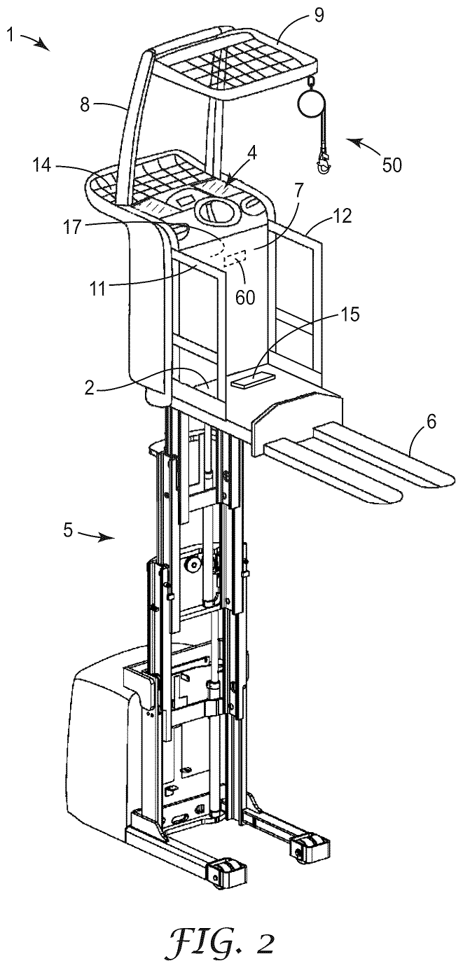

Disclosed herein are a fall-protection apparatus 50 and a fall-protection monitoring system as described in detail later herein. Such apparatus and systems can be used with aerial lifts, as exemplified by so-called order pickers; an order picker 1 is shown in exemplary, generic representation in FIG. 1. Order pickers are material-handling vehicles that are widely used to pick items from vertical stacks, from shelves of various heights, and so on. As shown in exemplary embodiment in FIG. 1, an order picker is a motorized vehicle having a generally horizontal platform 2 that supports a human user (operator) of the order picker and that is elevatable to a considerable height as shown in exemplary embodiment in FIG. 2 (noting that the order picker depicted in FIG. 2 differs in various aspects from the order picker depicted in FIG. 1). The operator typically stands on operator-support platform 2, but in some embodiments platform 2 may be provided with a seat, stool or the like. In some embodiments, the order picker includes manual input devices (controls) 4 that allow the operator to operate the order picker, e.g. to steer the order picker, to manually drive the order picker from place to place, to raise and lower the operator-support platform, and so on. Such manual input devices may include e.g. a steering wheel or joystick, a forward-reverse control and a speed control, an elevate/descend control, an “inching” or “jogging” button for slow movement or fine adjustment of the position of the order picker, and so on. In some embodiments, at least some functions (e.g. the horizontal movements) of the aerial lift may be automatically controlled (e.g. remotely controlled or autonomously controlled) rather than being manually controlled by the operator, as discussed later herein.

As shown in exemplary embodiment in FIG. 2, an order picker will often comprise a telescoping mast assembly 5 comprising multiple telescoping sections (e.g. two, three or more) that allow platform 2 to be elevated to a considerable vertical height (e.g., 1, 2, 4, 6, 8 or 10 meters or more). Order pickers allow an operator on operator-support platform 2 to be positioned so that the operator can manually grasp one or more items and remove them from an elevated location, e.g. from a shelf or stack. In some instances, the operator may place such items on a tray 14 of the general type shown in FIG. 2. In some embodiments, an order picker will comprise a set of forks 6 that allow larger items to be removed from an elevated location. An order picker (and, an aerial lift in general) thus comprises an operator-support platform 2 that is vertically movable between a first. “lowered” position in which the platform is proximate the ground or floor upon which the order picker resides (and in which condition the order picker may be horizontally moved, e.g. driven), and a second, “elevated” (raised) position. The second, raised position may, at any given time, be any of a plurality of elevated-height positions, e.g. as chosen by the operator in order to reach a particular item. By definition, a second raised or elevated position will be at least 4 inches above the first, lowered position.

In many embodiments, an order picker will comprise a console 7, which may present the above-described controls 4 for use by the operator. Often various electronic components, e.g. control circuitry 17, and so on, as needed to operate the order picker, may be located generally within console 7. In many cases an order picker may comprise a generally vertical wall or panel 8 that rises above the console and that supports a generally horizontal overhead guard (roof) 9. Descriptive terms such as wall and roof are not meant to limit such entities to purely continuous (e.g. unbroken or uninterrupted) structures. Any such entity may, for example, take the form of e.g. one, two or more beams, columns, or the like (as in the exemplary design of FIG. 2), with at least some empty space provided e.g. so that the user can access a tray 14 if needed.

Typically, console 7, panel 8, and roof 9 are in fixed relation to operator-support platform 2 so that these components move vertically in unison with platform 2. In many embodiments at least portions of panel 8 and/or roof 9 may be transparent to enhance the operator's visibility of the horizontal and vertical surroundings. For example, in many embodiments at least a portion of panel 8 may comprise a grid or mesh of widely-spaced wires, as shown in exemplary embodiment in FIG. 1.

As noted above, an aerial lift, e.g. an order picker, will comprise a fall-protection safety apparatus 50 and a fall-protection monitoring system. The fall-protection monitoring system will be configured to send a first positive signal to the control circuitry of the aerial lift as discussed in detail later herein. Various components of the fall-protection monitoring system may be installed on or in one or more components of the fall-protection safety apparatus and/or may be installed on the aerial lift itself, or integrated into the aerial lift. The aerial lift will comprise at least one safety apparatus in addition to the fall-protection apparatus. Any such safety apparatus will be referred to as an “additional” safety apparatus and is monitored so that an “additional” positive signal can be sent to the control circuitry of the aerial lift. Typically, the components of any such additional safety apparatus, and systems for monitoring the status of any such additional safety apparatus, will be installed into or onto the structure of the order picker itself, and will usually be powered by the order picker rather than relying on a separate power source.

One such additional safety apparatus that may be present is an Operator Presence Control (OPC) switch 15 as shown in exemplary embodiment in FIGS. 1 and 2. An OPC switch is a switch that must be engaged in order for at least some functions of the order picker to become enabled, and must be maintained in the engaged condition in order for these functions of the order picker to remain enabled. In some embodiments, the order picker will not move vertically (but may still be able to move horizontally) unless the OPC is engaged. In some embodiments, an order picker will not move horizontally or move vertically unless the OPC switch is engaged (so that the OPC switch is in a “ready” position). This enabling and disabling of various functions of the order picker will be controlled by control circuitry 17 of the order picker, based on signals received from the OPC switch.

An OPC switch (sometimes referred to as a deadman switch, vigilance control switch, or driver presence sensor), serves the purpose of ensuring that the operator of the order picker is present (e.g. is standing on platform 2) and is in active control of the order picker rather than being e.g. incapacitated. When the OPC switch is in a ready position indicative of active control of the aerial lift by the user (operator) of the lift, the OPC switch will send an additional positive (ready) signal to the control circuitry of the order picker; based on this additional positive signal, the control circuitry of the order picker will keep certain functions of the order picker enabled. In the absence of such an additional positive signal, the control circuitry will disable at least some functions of the order picker. An additional positive signal from an OPC switch will be termed a primary additional positive signal to distinguish it from other positive signals discussed below. In some embodiments the OPC switch may send such a signal wirelessly; however, in many embodiments it may be convenient that the OPC switch have a wired connection to control circuitry 17 for such purposes.

In some embodiments, an OPC switch 15 may take the form of a pedal that can be pressed by the operator's foot to move the pedal from an upward, disengaged position to a downward, engaged position.

The pedal is biased toward the upward, disengaged position, which position is indicative that no active control of the order picker by a human operator is occurring. The downward position is indicative that active control is present, and will cause the primary additional positive signal to be sent to the control circuitry of the order picker indicating that the OPC switch is in a ready condition indicative of active control by a human user. The term “pedal” is used in general to denote any item that is suitably pressable by the operator's foot. Such an item may be e.g. a “button” mounted directly on the floor of platform 2 (as in FIGS. 1 and 2) or may e.g. extend rearward from a lowermost portion of console 7 in the general manner of a piano pedal. Or, such an item may be positioned within a recess at the lowermost portion of console 7, so that the operator is to insert their foot slightly into the recess to reach to the OPC switch. In some embodiments, an OPC switch may be relatively large (or, two OPC switches may be provided) so that the operator can shift their position, can alternate which foot is used to press the switch, in order to enhance the comfort of the operator. In other embodiments, an OPC switch may take the form of e.g. a member that must be grasped or squeezed by the user's hand in order to be put into an engaged position. It will thus be understand that an OPC switch may take any suitable physical form and can be in any appropriate location. Whatever the form, in many embodiments the OPC switch will be biased toward a disengaged position and will thus require an operator to actively engage the OPC switch to an engaged position.

In some embodiments, an OPC switch may take the form of e.g. one or more sensors that confirm that an operator's foot has been put into a specific location that confirms that the operator is present and is in active control of the order picker, without the operator necessarily needing to apply pressure with their foot. It is thus noted that an OPC “switch” does not necessarily have to take the form of a physical switch. In fact, in some embodiments one or more cameras and associated image-processing circuitry may be configured to serve as an OPC “switch”, as discussed in detail later herein.

Another additional safety apparatus of an order picker that may be present is a safety gate apparatus. As shown in exemplary embodiment in FIGS. 1 and 2, such a safety gate apparatus may comprise at least one safety gate. In many embodiments, the safety gate apparatus will comprise first and second (e.g., left and right, from the perspective of FIG. 1) gates 11 and 12 as shown in exemplary embodiment in FIGS. 1 and 2. In some embodiments, at least one such gate will be movable; often, both gates will be movable, between a stowed position and a protective (ready) position (such gates are often referred to as retractable side gates). In a protective position, a gate will be disposed generally above a lateral (left or right) edge of operator-support platform 2 with the two gates combining to laterally flank, e.g. to partially enclose, platform 2 as evident from FIG. 2. In a stowed position, a gate will be in a non-protective position (e.g. pivotally moved upward as with gate 11 of FIG. 1) that, e.g., allows an operator to step onto platform 2 while the order picker is in its first, lowered position.

The term “gate” is used to generally encompass any member, beam, rail, or set of such members that can function in the manner described above. In some embodiments, one or both such gates may be e.g. pivotable about a pivotal connection to order picker 1 so that the gate can be opened (e.g. raised) into a stowed position that allows an operator to step onto platform 2 and can then be closed (e.g. lowered) into a protective position. In some embodiments, the gates may be independently operable so that one may be in a stowed position while the other is in a protective position (e.g. as in the exemplary embodiment of FIG. 1); in other embodiments the gates may operate in unison. In some embodiments, one or both gates may be manually openable and closable e.g. by way of controls located on console 7 of the order picker; in some embodiments, one or both gates may be configured to automatically close or open under certain conditions.

The above-described arrangements are exemplary and that many arrangements of such gates are possible. For example, some such gates, or at least a portion thereof, may pivotally move upward, rather than downward, into a protective (closed) position. Some gates may have one or more portions that move slidably rather than pivotally. In some embodiments, a gate may comprise one or more vertical members, columns or panels (e.g. as in the exemplary arrangement of FIG. 2). In some embodiments one or more such vertical members may e.g. swing downward from an upper rail of the gate (e.g. to contact platform 2) as the gate moves into a closed position; or, such a member may be in fixed relation to a rail of the gate. Any such arrangement of closed gates may border, e.g. may at least partially enclose, the lateral sides of operator-support platform 2. In some embodiments, an additional gate may be provided at or near the rear of platform 2 (e.g. at a location generally opposite console 7). However, in some embodiments this end of platform 2 may be left relatively open so that the operator can easily reach and grasp an item that is to be removed from an elevated location.

A safety gate apparatus may be configured with a sensing system that advises the control circuitry 17 of the order picker whether each gate that is movable is in its stowed position or in its protective position. In particular, when all such movable gates are in a protective (ready) position, the sensing system of the safety gate apparatus will issue an additional positive (ready) signal indicating that the safety gate apparatus is in a protective condition. This positive signal will be termed a “secondary” additional positive signal to distinguish it from the positive signal from the OPC switch, which was termed a “primary” additional positive signal.

Thus in some embodiments, in order for the control circuitry 17 of the order picker to enable certain functions of the order picker and to keep them enabled, the control circuitry will need to receive a secondary additional positive signal from the safety gate apparatus, e.g. in addition to receiving a primary additional positive signal from the OPC switch as described above. In the absence of such a secondary additional positive signal, the control circuitry will disable at least some functions of the order picker. In some embodiments the sensing system of the safety gate apparatus may send such a signal to the control circuitry wirelessly; however, in some embodiments the sensing system of the safety gate apparatus may have a wired connection to the control circuitry of the order picker for such purposes.

As summarized above, in some embodiments the order picker may have two safety apparatus (e.g. an OPC switch and a safety gate apparatus) in addition to the herein-described fall-protection apparatus. In such embodiments the control circuitry of the order picker may need to receive three positive/ready signals (a “first” positive signal from the fall-protection monitoring system, an additional positive signal from the OPC switch, and another additional positive signal from the safety gate sensing system) in order to enable certain functions of the order picker. In some embodiments, the order picker may have one or more additional safety apparatus installed thereon and thus may require one or more additional positive signals from the additional safety apparatus in order to enable the functions of the order picker. For example, one such additional safety apparatus may be an operator authentication apparatus that (e.g. by scanning an RFID tag, barcode, NFC code or QR code of a person's badge) may confirm that the person is trained and authorized to operate the order picker. Proper authentication may result in a tertiary additional positive signal being sent to the control circuitry of the order picker. If the order picker is equipped with additional safety apparatus, one or more additional positive signals, e.g. a quaternary additional positive signal, may similarly be sent to the control circuitry.

In various embodiments, any or all of a primary, secondary, tertiary, and quaternary additional positive signal may be sent to the control circuitry of the aerial lift, in addition to the “first” positive signal that will be sent by the fall-protection monitoring system and that is described in detail later herein. It is emphasized that any combination of such signals may be used. Terms such as primary, secondary, and so on, are used for convenience of description only. For example, in some embodiments, an interlocking system may rely on a tertiary signal from an operator authentication apparatus regardless of whether the interlocking system also relies on a secondary signal from a safety gate sensing system.

As noted, any of these signals may be sent to the control circuitry of the order picker wirelessly or via one or more wired connections. In some instances any or all of these signals may be sent continuously. However, this does not necessarily have to be the case; in some instances a primary, secondary, tertiary signal, and so on, may be sent intermittently or periodically as long as the transmission frequency is high enough that a change in the state of the safety apparatus will be communicated to the control circuitry sufficiently quickly.

An aerial lift, e.g. an order picker 1, will be equipped with a monitored fall-protection apparatus 50 as disclosed herein. As shown in exemplary embodiment in various Figures, such a fall-protection apparatus 50 may be used as part of a fall-protection system that includes a harness 40 configured to be worn by a human operator of the aerial lift. Fall-protection apparatus 50 will comprise a safety line 52 (which may take the form of e.g. a metal cable, a DYNEEMA webbing, and so on), a distal end of the safety line being equipped with a connector 30 configured to be connected to the harness 40. (Other components may be present as well, as will be well understood by artisans in the field.)

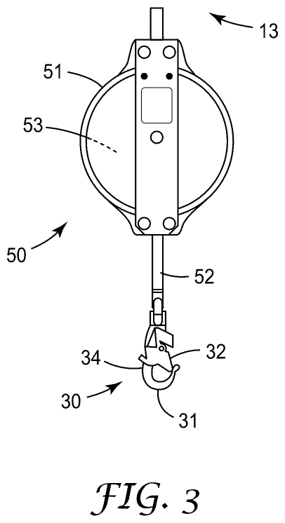

A connector 30 may be referred to herein by the generic terminology of “hook” or “gated hook”; however, it will be understood that some such connectors are often referred to as carabiners, with there not necessarily being a firm dividing line between the two. Many such hooks and carabiner (as illustrated in further detail in exemplary embodiment in FIG. 3) will comprise a hook body 31 and a movable gate 32 and thus will be termed a gated hook. In at least some embodiments, any such connector will be compliant with ANSI standard Z359.12-2019. In some embodiments a connector may be a double-action connector (i.e. with a gate that requires at least two consecutive, different actions to open). One category of double-action connectors are so-called twist-lock hooks and carabiners of the general type exemplified by the product available from 3M Fall Protection under the trade designation KJ5108 HOOK CONNECTOR and various connectors available from 3M Fall Protection under the trade designation SAFLOK. In such connectors, a locking mechanism of the gate of the connector must be twisted (e.g. at least a quarter turn, around an rotation axis aligned with the long axis of the gate) in order to unlock the gate so that it can then be opened. In various embodiments, such a locking mechanism may be e.g. a collar fitted on a portion of the gate; or, the entirety of the gate may be twistable. Some such double-action connectors (e.g. products available from 3M Fall Protection under the product numbers 2000300 and 2000301) are actually triple-action connectors in which the gate must be moved slightly along its long axis before it can be rotated to allow the gate to be opened. Another category of double-action connectors are so-called snap hooks (or locking snap hooks) in which a locking mechanism must be moved (e.g. pressed inward or squeezed) before the gate of the hook can be opened. Such connectors include those available from 3M Fall Protection under the products numbers 2007153 and 9510057. All such items will be considered to be connectors as defined herein, and may be referred to generically as gated hooks.

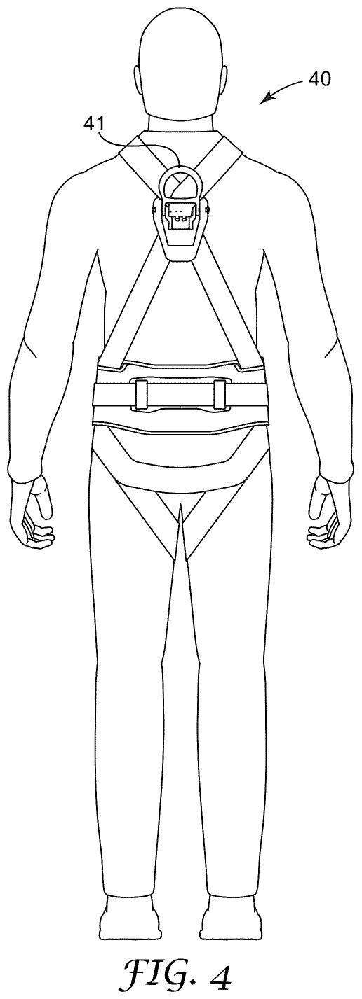

In many embodiments a connector 30 of a safety line 52 may be configured to be connected to a harness 40 by being attached to a D-ring that is non-removably mounted on the harness. In particular embodiments the connector may be attached to a dorsal D-ring 41 of the general type illustrated in FIG. 4. It is emphasized that the term “D-ring” generically encompasses any item that is attached to a fall-protection harness and that is purposefully configured to have a connector of a safety line attached thereto. Such an item does not necessarily have to exhibit any specific shape; in particular, such an item does not need to be strictly D-shaped. In some embodiments, a connector of a safety line (and the associated “D-ring” of a harness) may be a matched pair of connectors (e.g. one on a safety line and one on a harness; or, on ends of first and second straps, lines or the like) that are specifically configured to be mateable or otherwise engageable with each other but not to be mateable to other types of connectors. In some embodiments such connectors include modular connectors of the general type described in the 3M DBI-Sala Fall Protection Full-Line Catalog 2017 as being supplied as components of Modular Lanyards such as e.g. the EZ-STOP MODULAR LANYARD. Such connectors may, for example, comprise a female connector with a generally T-shaped slot configured to accept a generally T-shaped bar of the other, male connector. In many embodiments, such connectors may be lockable when engaged so that they cannot be disengaged from each other without a prior, purposeful manipulation that places them into an unlocked condition in which they can be disengaged from each other. In some embodiments, such connectors include so-called quick connectors of the general type supplied as a component of e.g. the 3M DBI-SALA NANO-LOK Self-Retracting Lifeline, quick-connect buckles of the general type supplied as a component of e.g. the 3M DBI-SALA EXOFIT STRATA Harness, and the like. In many embodiments fall-protection apparatus 50 may be a so-called self-retracting lifeline (“SRL”) as shown in exemplary embodiment in FIGS. 1-3. Ordinary artisans will understand that a self-retracting lifeline comprises a load-bearing safety line (“lifeline”) 52 that can be unwound from a housing 51 which may be secured to an anchorage 13 located e.g. on an overhead guard or panel (“roof”) 9 of the aerial lift. A distal end of safety line 52 is connectable, e.g. by way of a connector (e.g. a gated hook) 30, to a D-ring 41 of a harness 40. SRL housing 51 comprises a reel (drum) 53 (indicated generically in FIG. 3) that is rotatably connected to housing 51, with a proximal end of safety line 52 being attached to reel 53. Safety line 52 can be unwound from reel 53 and thus extended from housing 51 to follow a user as the user moves about, with reel 53 being biased so that the reel retracts safety line 52 back into housing 51 and rewinds it onto reel 53 as the user moves toward housing 51. Some such SRLs (e.g. housing 51 and reel 53 thereof) may include a brake, e.g. comprising centrifugally-activated pawls that act in cooperation with a friction pad or the like, that is triggered in the event of a user fall (e.g. upon rapid unwinding of safety line 52 from reel 53) to safely bring the user to a halt. Some such SRLs may feature a safety line that is equipped with an energy absorber in the form of a so-called tear-strip or shock-pack. Such energy absorbers often rely on several segments of safety line, e.g. webbing, that are accordion-folded together and sewn to each other so that they can “unzip” from each other in a manner that absorbs energy in the case of a fall. In some embodiments at least a lower portion of the housing 51 of an SRL may be covered by a soft cover; for example, in some embodiments substantially the entirety of housing 51 may be contained e.g. within a padded canvas cover that comprises a lower opening to allow safety line 52 to pass therethrough and an upper opening to allow the housing to be secured to an anchorage.

Fall-protection apparatus such as self-retracting lifelines and components and functioning thereof are described in various aspects in U.S. Pat. Nos. 7,843,349, 8,256,574, 8,430,206, 8,430,207, and 9,488,235. In some embodiments a self-retracting lifeline will meet the requirements of ANSI Z359.14-2014.

Any such fall-protection apparatus may be configured to allow an operator of an aerial lift (e.g. an order picker) to perform actions as needed while the operator-support platform of the aerial lift is in an elevated condition. For example, the operator will be able to operate the aerial lift controls, to reach for and retrieve an item on an elevated shelf proximate the elevated platform of the lift, and so on. A fall-protection apparatus in the form of an SRL may further provide that the operator can move about for short distances as needed while remaining connected to the safety line (e.g. can momentarily step off the platform of the aerial lift when the aerial lift is in its “lowered” position), to the extent that any such actions are permitted by the work facility at which the aerial lift is used.

An aerial lift as disclosed herein will comprise a fall-protection monitoring system configured to determine whether the connector 30 of the safety line 52 of the fall-protection apparatus appears to be connected to a safety harness 40 (e.g. to a D-ring 41 of the safety harness) worn by a user of the aerial lift 1 with which the fall-protection apparatus 50 is used. The fall-protection apparatus 50 and the safety harness 40 may thus combine to form a fall-protection system. However, these items need not stay together at the aerial lift at all times; for example, a fall-protection apparatus such as an SRL may be resident on the aerial lift and remain with the aerial lift, while a safety harness may be worn by the operator even while the operator is disconnected from the SRL and is away from the aerial lift.

A fall-protection monitoring system for a fall-protection apparatus may, in some convenient embodiments, comprise at least one sensor module and at least one base unit, as discussed in detail later herein. Any such fall-protection monitoring system will be configured so that if the monitoring system determines that the connector appears to be connected to the safety harness, the fall-protection monitoring system will issue a positive (ready) signal that can be received by the control circuitry of the aerial lift. A positive signal that is issued by the fall-protection monitoring system of the fall-protection apparatus indicating that the connector appears to be connected to the safety harness (i.e., that the fall-protection apparatus is in a ready condition), will be termed a “first” positive signal to distinguish it from the “additional” positive signals described previously (e.g. a primary additional positive signal issued by an OPC switch of the aerial lift, a secondary additional positive signal issued by a safety gate apparatus of the aerial lift, a tertiary additional positive signal issued by an authorization safety apparatus of the aerial lift, and so on).

### Interlocking of Aerial Lift with Safety Apparatus

As disclosed herein, an aerial lift 1 is interlocked with the fall-protection apparatus 50 and with at least one additional safety apparatus of the aerial lift. By this is meant that in order for at least the vertical-motion function of the aerial lift to be enabled, the control circuitry of the aerial lift must receive a first positive signal from the fall-protection monitoring system indicating that the connector of the safety line appears to be connected to the safety harness of the user (that is, that the fall-protection apparatus is in a ready condition); and, the control circuitry of the aerial lift must receive at least one additional positive signal from at least one additional safety apparatus of the aerial lift indicating that the at least one additional safety apparatus is in a ready condition. In some embodiments, the control circuitry may need only receive an additional positive signal from an OPC switch in order to enable at least the vertical-motion function of the aerial lift. In other embodiments, the control circuitry may need to receive a primary additional positive signal from the OPC switch and to receive a secondary additional positive signal from a safety gate apparatus, in order to enable at least the vertical-motion function. In still other embodiments, the control circuitry may need to receive either or both of these additional positive signals along with a tertiary additional positive signal from an authorization safety apparatus, in order to enable at least the vertical-motion function. Any combination of these additional positive signals (whether totaling up to one, two, three, four, or more additional positive signals) may be used, with the caveat that the first positive signal, from the fall-protection safety apparatus, will always be required.

In some embodiments, an aerial lift may be configured so that the vertical-motion function of the aerial lift is not enabled in the absence of the above-discussed positive signal(s), in a substantially absolute manner. By this is meant that the operator-support platform lift cannot be elevated from a first, lowered position (which is typically the lowest position to which the platform can be lowered and is the position that allows the operator to step onto the platform), to an aforementioned second, elevated position, in the absence of a first positive signal from the fall-protection monitoring system. In other words, such an aerial lift will be substantially unable to elevate any significant amount unless the fall-protection monitoring system reports that the operator appears to be connected to the fall-protection apparatus.

However, in some embodiments, it may be permissible, or even advantageous, for an aerial lift to operate in a mode in which a predetermined, limited amount of vertical elevation is allowable in the absence of the aforementioned positive signal(s). In other words, in some embodiments it may be possible to elevate the operator-support platform to a maximum height of e.g. 1.0, 1.5, 2.0, 3.0, 3.5, or 3.9 feet (relative to the first, lowered position) even if the fall-protection monitoring system has not reported that the operator appears to be connected to the fall-protection apparatus. Such a mode may allow at least some limited use of the aerial lift without the operator being connected to the fall-protection apparatus (with the stipulation that an aerial lift may only be used in this manner if this is allowed by all applicable laws, rules, codes, standards, and so on).

It is thus emphasized that the concept of enabling a vertical-motion function of an aerial lift upon receipt of positive signals as disclosed herein does not encompass only cases in which substantially no vertical elevation is possible in the absence of the positive signals. Rather, such terminology also encompasses cases in which the enabling of the vertical-motion function enables vertical elevation of the operator-support platform beyond a predetermined, limited height (e.g., of 1-4 feet) that is allowed even in the absence of the positive signals.

In some embodiments, only the vertical-motion function of the aerial lift may be enabled and disabled according to the control circuitry of the aerial lift receiving, or not receiving, the various positive signals discussed above. That is, in some embodiments the aerial lift may still be able to move horizontally regardless of the signals issued by the fall-protection monitoring system and/or by the at least one additional safety apparatus. In other embodiments, both the vertical-motion function and the horizontal-motion function of the aerial lift may be enabled and disabled in the manner described above (that is, both of these functions may be interlocked with the fall-protection apparatus and the at least one additional safety apparatus). In such embodiments, the aerial lift may be unable to move at all, in any direction, unless the above-discussed positive signals are received by the control circuitry of the aerial lift. In some embodiments, the status of one or more of the above-described additional safety apparatus may have an effect on the functioning of the aerial lift that, in some circumstances, is independent of the signals issued by the fall-protection monitoring system. Thus for example, even if an aerial lift might be able to be moved horizontally in the absence of a first positive signal from the fall-protection monitoring system, the aerial lift may nevertheless need to receive e.g. a tertiary positive signal confirming that a person is a trained an authorized user of the aerial lift, in order for the aerial lift to be moved horizontally.

It will be appreciated that in various embodiments, fall-protection monitoring system may or may not actually issue a negative (not ready) signal indicating that the connector of the fall-protection apparatus does not appear to be connected to the harness of the user of the aerial lift. That is, in some embodiments, the control circuitry of the aerial lift may take action (or, strictly speaking, may prevent action from being taken) based solely on the absence of a positive (ready) signal. In other embodiments, the fall-protection monitoring system may actually issue a negative (not ready) signal that is received by the control circuitry of the aerial lift. The same holds true of the OPC switch and the safety gate apparatus—the control circuitry may be configured to receive a negative/not ready signal or may be configured to act merely upon the ceasing or absence of a positive/ready signal.

As noted earlier herein, an aerial lift (e.g. an order picker) will typically comprise a console 7 bearing various input devices 4 that are contacted (e.g., grasped) by a user of the aerial lift and are manipulated to manually control the operation (e.g., vertical and horizontal movement) of the aerial lift. Such manual control input devices may take the form of e.g. one or more wheels, levers, joysticks, yokes, knobs, buttons, and so on, and may be manipulated e.g. by pushing, pulling, rotating, twisting, tilting, touching, and so on. When a vertical-motion function of the aerial lift is disabled as described above, the particular manual control input device or devices that is normally manipulated to cause the lift to perform the vertical motion, will be locked-out so as to be unresponsive when manipulated by the user in an attempt to input a command for movement. When the vertical-motion function is enabled, the device or devices will be responsive to attempted input by the user. Similarly, if an aerial lift is configured so that a horizontal-motion function of the aerial lift is disabled in addition to the disabling of the vertical-motion function, the manual control input device or devices that are normally manipulated to cause the lift to perform the horizontal motion, will be locked out so as to be unresponsive. When the horizontal-motion function is enabled, the device or devices will be responsive.

In various embodiments, communications between the fall-protection monitoring system (e.g. a base unit thereof) and the control circuitry of the aerial lift may be one-way, or two-way. If the communication is one-way, the base unit will be configured to send transmissions that are received by the control circuitry, but the control circuitry (or any other associated item or component of the aerial lift) will not be configured to send transmissions that are receivable by the base unit. If the communication is two-way, both the base unit and the control circuitry will be able to send/receive so that information can be exchanged in both directions between the two entities.

In some embodiments, two-way communication can provide that the control circuitry of the aerial lift can send the fall-protection monitoring system information regarding the vertical elevation of the operator-support platform of the aerial lift. In other words, the control circuitry can keep track of the height to which the platform has been raised and can pass this information along to the fall-protection monitoring system, which may be particularly useful in some circumstances. For example, the fall-protection monitoring system can be configured so that if the fall-protection monitoring system determines that the connector of the safety line appears to have become disconnected from the safety harness of the user while the operator-support platform is in a vertically-elevated condition, the fall-protection monitoring system may issue an unhooked while elevated warning notification. (The general topic of notifications that may be issued by a fall-protection monitoring system and/or by the control circuitry of an aerial lift, is discussed in detail later herein.) Such a warning notification may take any suitable form and may have a particular form that distinguishes it from other notifications. For example, it may comprise a louder or more strident audible signal, a visual signal that is brighter, flashing more quickly, and/or of a different color, a particularly noticeable haptic sensation, and so on. If the warning notification includes verbiage, it may take any suitable form (and does not have to necessarily take the form of the exact phrase “Unhooked While Elevated”).

A platform-elevation height that is necessary to trigger such a warning notification may be any suitable value, e.g. 1.0, 2.0, 3.0, 4.0, 5.0, or 6.0 feet or greater (noting that these and other heights disclosed herein are relative to the first, lowered position of the platform). Such a height may be preset in manufacture of the aerial lift and/or of the fall-protection apparatus (and thus may be unchangeable); or, in some embodiments it may be programmable or customizable by an authorized person in the facility in which the aerial lift is used.

In some embodiments, the at least one sensor module of the fall-protection monitoring system may comprise at least one sensor that is in the form of an accelerometer, e.g. a multi-axis accelerometer. In some circumstances, such a sensor may augment the previously-discussed sensor-obtained information with further information e.g. as to the angle that the connector is residing at, the motions that the connector is undergoing, and so on. In some circumstances, such additional information may e.g. provide additional confirmation that the connector is e.g. attached to a D-ring of a harness that is currently worn by the human user of the aerial lift. In other words, the attitude at which a connector resides, and/or the motions that the connector undergoes, may be useful in confirming that the connector is residing, and/or moving, in a way that is characteristic of that expected when the connector is connected to a D-ring of a harness that is being worn by a person standing on the operator-support platform. It is noted that such additional information may not be needed in most situations and that the presence and use of an accelerometer in this manner should be regarded as an optional feature.

It has been noted previously herein that in some embodiments, an aerial lift may be configured so that the absence of a first positive signal from a fall-protection apparatus, and/or the absence of an additional positive signal from an additional safety apparatus of the aerial lift, can cause both the vertical-motion and horizontal-motion capability of the aerial lift to be disabled. In some such embodiments, it may be useful to provide for a privileged mode of operation in which the restrictions on horizontal motion can be overridden but in which restrictions on vertical motion can be maintained. Such a mode may be useful in situations where the ability of the aerial lift to propel itself horizontally under its own power may be advantageous (e.g. so that the aerial lift does not have to be lifted and carried by a forklift), but in which it is not needed or desired to elevate the aerial lift. Such a situation may arise e.g. when an aerial lift is being initially rolled off the production line, is being self-conveyed into an end-use facility after having being unloaded from a delivery truck, is undergoing maintenance, and so on. (It is thus envisioned that the need for such a mode of operation will only arise occasionally.)

To provide for such eventualities, in some embodiments the control circuitry of the aerial lift can be configured so that if predetermined conditions are met, the control circuitry will allow a privileged mode of operation. When such a mode is entered, at least the one or more manual control input devices that control horizontal motion of the aerial lift are activated to a state in which they are responsive to control inputs regardless of whether a first positive signal is issued by the fall-protection system. Typically, the restrictions applied by the additional safety apparatus of the aerial lift will remain in place; e.g. the aerial lift will not be able to be moved horizontally unless the OPC switch is engaged and the safety gate apparatus is in a ready condition.

A predetermined condition that must be met to allow such a mode of operation can be anything that confirms that a particular user of a particular aerial lift is authorized to operate the aerial lift in privileged mode. Such a predetermined condition may take the form of e.g. a user entering a special password or code into a keypad of the aerial lift or a base unit of the fall-protection monitoring system, may take the form of a user having a special badge that, e.g. upon being read by the aerial lift or the base unit, authorizes the privileged mode, and so on. Any arrangement of this general type may be used. In some such embodiments, during any such privileged mode, one or more notifications may be issued (e.g. in the form of special audible or visual signals) that signify that the aerial lift is currently being operated in privileged mode.

In a special case of this arrangement, in some embodiments an aerial lift may be configured so that under certain circumstances it can be operated in a special-privilege mode in which both horizontal and vertical movements of the order picker are allowed regardless of whether a first positive signal is issued by the fall-protection system. Since such a mode will temporarily negate the advantages of the herein-disclosed arrangements, it is envisioned that the ability to operate in such a mode, if allowed at all, would only be allowed for very short times under very particular circumstances.

In ordinary use of many aerial lifts (e.g. order pickers), only a single user/operator will be present, e.g. standing on the operator-support platform. However, in some embodiments, multiple (e.g. two or more) persons may be present. This may occur, for example, when a person is being trained to operate an aerial lift, or if the aerial lift is being used for a procedure that involves two or more persons. To allow for such eventualities, in some embodiments an aerial lift may comprise a “multi-user” operating mode in which the control circuitry is required to receive two first positive signals, one confirming that a connector is connected to the harness of a first user (e.g. a “trainer”), and another confirming that a second, separate connector is connected to the harness of a second user (e.g. a “trainee”), in order to enable the vertical-motion function of the aerial lift.

In some embodiments, a chosen aerial lift may be equipped with two fall-protection apparatus that are permanently resident on the aerial lift, e.g. to serve as a “trainer” lift. In some embodiments, a “mobile” fall-protection apparatus may be configured so that it can be installed for a desired time on an aerial lift that already has a “resident” fall-protection apparatus. In various embodiments, a fall-protection monitoring system may be configured so that it can monitor both such fall-protection apparatus; or, two separate monitoring systems can be used. Whatever the arrangement, the aerial lift will be configured such that when the aerial lift is in a “multi-user” mode, the control circuitry of the aerial lift must receive a first positive signal indicating that the connector of the first fall-protection apparatus appears to be connected to the harness of a first user, and must also receive another first positive signal indicating that the connector of the second fall-protection apparatus appears to be connected to the harness of a second user. Only upon receipt of both positive signals (along with any other additional positive signal of the types discussed earlier herein) will the vertical-motion function of the aerial lift be enabled.

In some instances, an aerial lift may be able to detect (e.g. via a camera-based sensing system as described later) that two (or more) persons are present on the operator-support platform of an aerial lift, and to provide this information to the operating circuitry of the aerial lift so that the aerial lift will accordingly enter a “multi-user” mode. An aerial lift can also be configured so that a user can enter a command for the aerial lift to enter a multi-user mode.

Although discussions so far have focused on manual control of an order picker, it will be appreciated that in some embodiments the arrangements disclosed herein may be used in concert with an order picker whose movements are guided at least in part by automatic control rather than by manual inputs of a human user. Such an aerial lift may, for example, follow designated paths in a warehouse, with the horizontal movements of the aerial lift being directed by a central station that plans and directs the horizontal travel of many such aerial lifts. Such guided horizontal movements of a lift may be facilitated by an automatic control system comprising e.g. any suitable combination of tracking indicia (e.g. RFID tags) provided on the floor of the warehouse; guidewires embedded in the floor of the warehouse; floor-mounted physical rails followed by guide rollers on the aerial lift; cameras operating in conjunction with computer-vision software; radar/lidar sensors; global-positioning system (GPS) tracking; geofencing that defines multiple geofenced zones within the facility; logic circuits within the control circuitry of the aerial lift; and so on, e.g. in combination with orders issued by a centralized directing station.

Upon arriving or nearing arrival at a destination, a user may manually elevate the aerial lift as needed; or, in some embodiments, the automatic control system may initiate and control the elevating of the lift, subject to the constraints imposed by the fall-protection monitoring system. The arrangements disclosed herein may be used in such circumstances by configuring the control circuitry of the aerial lift so that unless the control circuitry receives a first positive signal from the fall-protection monitoring system, the vertical-elevating function of the aerial lift will be disabled so that it cannot be elevated in response to manual inputs or in response to inputs received from an automatic control system. In some such embodiments the disabling may occur at least in part in the guise of decisions made by logic circuits within the control circuitry of the aerial lift (e.g., a decision to not elevate the aerial lift) rather than by any actual disabling of manual input devices that would be used by a human operator to control the aerial lift. (In some scenarios such decisions might be made by logic circuits within the centralized directing station; however, in many instances it may be more convenient for such decisions to be made on-board the aerial lift itself.) All such scenarios are encompassed within the arrangements disclosed herein.

Thus in some embodiments, the arrangements disclosed herein may be used in a highly automated facility such as a distribution center that utilizes a so-called warehouse management system that governs many or all aspects of the tasks for which a centrally-directed fleet of fall-protected aerial lifts is used. Such a system may choose and optimize the horizontal travel paths of some or all of the individual aerial lifts, may establish the appropriate workflow strategy (e.g. piece picking, batch picking or zone picking), may subject the aerial lifts to specific workflow and travel optimizations (sometimes referred to as zoning and positioning functions), and so on. In such environments, the information received from the fall-protection monitoring system regarding the status of the fall-protection apparatus will be one more parameter that the control circuitry of each aerial lift takes into account and/or that the centralized directing station of the facility takes into account for each aerial lift, to be used in combination with all the other parameters that are needed for partial or full automatic control of the aerial lift(s).

In some embodiments, a fall-protection monitoring system as disclosed herein may serve merely to send a positive signal (ready), to not send a positive signal, and/or to send a negative (not ready) signal, to the control circuitry in the manner discussed above. This will enable the control circuity of the aerial lift to take appropriate action (e.g. to disable the controls so that the aerial lift cannot be elevated). In some embodiments, a fall-protection monitoring system may additionally serve to issue a notification. In some embodiments, such a notification will be a “Not Ready” warning in the event that the connector is detected as not appearing to be connected to the user's harness. In some embodiments, the monitoring system may be additionally configured to issue a “Ready” confirmation if the connector is detected as appearing to be connected to the user's harness.

By a notification is meant a signal that is intended for the user of the aerial lift, for one or more persons in the local surroundings, for one or more designated persons e.g. at a monitoring station. Such a notification is thus distinguished from, and will be issued in addition to, the previously-described signals that are sent to the control circuitry of the aerial lift. Such a notification may be e.g. an audible notification and/or a visual notification and/or a haptic notification. Such notifications may be issued locally (e.g. by providing the fall-protection monitoring system with lights or buzzers) or may be transmitted e.g. to a smartphone or to a remote monitoring station.

In some embodiments, the control circuitry of the aerial lift may be configured to issue notifications. Such notifications may take into account not only the status of the fall-protection apparatus but also the status of the OPC switch and/or the safety gate apparatus. Any such notifications may again include warning notifications, and may additionally include ready notifications. Such notifications as issued by the control circuitry of the aerial lift may take the form of e.g. audible, visual, and/or haptic/tactile notifications and may be issued locally (e.g. by way of lights or buzzers on the aerial lift itself) and/or may be transmitted e.g. to a smartphone or to a monitoring station. Thus by way of a specific example, a console 7 of an order picker may comprise at least one notification unit that displays a notification of the status of the fall-protection apparatus based on signals sent to the control circuitry of the order picker by the fall-protection monitoring system. Such a notification unit may take any suitable form, e.g. green light that illuminates when the monitoring system indicates that the fall-protection apparatus is in a “ready” condition; a red light that illuminates when the monitoring system indicates that the fall-protection apparatus is not in a ready condition; a set of red and green lights; a display screen that indicates a ready or not ready indication, and so on.

Any negative notification (whether presented by the fall-protection monitoring system itself or presented by the order picker based on signals received from the fall-protection monitoring system) that contains actual verbiage may take any suitable form, e.g. “Not Ready”, “Unhooked”, “Check Hook-up”, and so on. Similarly, any such positive notification may use any suitable verbiage, e.g. “Ready”, “Hooked Up”, and so on.

In some embodiments, a fall-protection monitoring system of a fall-protection apparatus (e.g. an SRL) may comprise a base unit 60 and at least one sensor module 34, the sensor module being configured to sense whether the connector appears to be connected to the safety harness and to communicate connector status information to the base unit. Such a sensor module may thus comprise at least one sensor to sense the condition of the connector, and a communication module that transmits this information (whether wirelessly, or by a wire or fiber optic cable) to the base unit. The base unit comprises a receiving module that can receive information from one or more sensor modules, and a transmission module that, based on the information received from the sensor module(s), can issue the aforementioned first positive signal to be received by the control circuitry of the aerial life. In some embodiments, the base unit may also comprise a notification module to emit or otherwise broadcast a notification as mentioned above.

In some embodiments the base unit may receive raw (or partially processed) data from one or more sensors of the sensor module and may perform any or all actual processing that is needed to ascertain the condition of the connector. In other embodiments, the raw data may be at least partially processed by circuitry that is resident within the sensor module itself. In at least some such cases, the base unit need only receive yes/no information from the sensor module that indicates whether the connector appears to be connected or not; and, depending on the information, can send a first positive signal to the control circuitry of the aerial lift.

In some embodiments, a sensor module 34 of a fall-protection monitoring system may be installed at a connector (e.g. a gated hook) 30 at a distal end of a safety line 52 of a fall-protection apparatus. Such terminology encompasses arrangements (illustrated generally in FIG. 3) in which the sensor module is located on the connector or is located proximate the connector (e.g. mounted on safety line 52 or on a protective shroud located thereon) as long as the sensor module is close enough to the connector to allow the condition of the connector to be successfully monitored, e.g. to evaluate whether the connector appears to have been attached to a D-ring. In some embodiments, a sensor module 34 may be installed within a housing (e.g. a molded plastic shroud) that is fitted over at least a portion of connector 30.

In some embodiments, a sensor module may be installed on a harness 40 to which connector 30 is to be attached. For example, a sensor module may be installed at a D-ring (e.g. a dorsal D-ring 41) that is non-removably attached to harness 40. Such terminology encompasses arrangements in which the sensor module is located on the D-ring or is located proximate the D-ring (e.g. on a strap or a dorsal plate of harness 40) as long as the sensor module is close enough to the D-ring to allow the sensor of the sensor module to evaluate whether a connector appears to have been attached to the D-ring. The arrangements disclosed herein thus encompass, for example, configurations in which a connector is monitored for an indication as to whether the connector appears to have been attached to a D-ring, as well as arrangements in which a D-ring is monitored for an indication as to whether a connector appears to have been attached to the D-ring.

Other arrangements are possible. In some embodiments a sensor module may be located at a docking station that is configured to accept connector 30 when connector 30 is not connected to the user's harness (such docking stations are discussed in further detail later herein). In embodiments in which the fall-protection apparatus is a self-retracting lifeline (SRL) 50, the SRL may comprise a sensor module that is configured to monitor the position of connector 30 relative to the housing 51 of the SRL. Such a sensor module might comprise e.g. a sensor that is on the housing and that is configured to ascertain whether connector 30 is in close proximity thereto. Or, such a sensor module might comprise a sensor that is configured to determine the distance to which safety line 52 has been paid out from housing 51 (such a sensor might be, for example, a rotary encoder that tracks the rotation of reel 53 to which the proximal end of safety line 52 is attached). Such a sensor module may thus be configured to provide an indication of, for example, whether connector 30 is snugged up tight against the SRL housing or is proximate (meaning within 0.2 meters of) the housing; or, whether connector 30 has been paid out a considerable distance (e.g. more than 0.2 meter) from the housing. Such information can be used, if desired, as an indication of the condition of the connector. For example, if the connector is reported to be snugged tight against the SRL housing, this may be inferred to be an indication that the connector does not appear to be attached to a harness of an operator.

The discussions above make it clear that a sensor module may be installed e.g. at a connector (e.g. a gated hook), at a harness D-ring to which the connector is to be attached, at a docking station to which the connector can be docked when not in use, or at an SRL housing from which a safety line bearing the connector can be extended. Any such arrangement, and any desired combination of such arrangements, is encompassed within the disclosures herein (noting that e.g. in a configuration in which sensor modules are installed at harness D-rings, a base unit (described below) may be configured so that the base unit is able to receive signals from any of multiple possible sensor modules of multiple harnesses).

A base unit 60 of the fall-protection monitoring system, that receives information from the sensor module(s) indicative of the condition of the connector, can be positioned in any suitable location. In some embodiments, a base unit 60 may be installed on the aerial lift. For example, a base unit 60 may be installed on or within a console 7 of the aerial lift, as respectively indicated in FIGS. 1 and 2. (In some embodiments, a base unit of the fall-protection monitoring system may be integrated into the circuitry of the aerial lift and may not necessarily reside e.g. in a housing that is physically separate from other items of the circuitry of the aerial lift.) In some embodiments, a base unit may be installed at the connector of a safety line (e.g. the base unit may be co-located with a sensor module that is on or proximate a hook). In some embodiments, a base unit may be installed on the harness, e.g. at a harness D-ring. In such embodiments, the base unit may be co-located with a sensor module that is installed at the D-ring and may receive signals therefrom; or, the base unit may be installed on the harness but may receive signals from a sensor module that is installed at the connector rather than at the D-ring. In some embodiments, a base unit may be installed at (e.g. on or within) a housing of a self-retracting lifeline.

Any of these are possible; however, in many convenient embodiments, a base unit 60 may be installed within a console 7 of the arial lift as noted above. This may advantageously position the base unit close to the control circuitry 17 of the aerial lift, and/or may make it convenient for the base unit to draw power from the aerial lift rather than having to have its own internal power supply. This may also make it easier for the base unit to transmit a first positive signal to the control circuitry of the aerial lift via a wired connection rather than wirelessly, although either of these may be acceptable. (In this context a “wired” connection broadly encompasses any physical connection using electrically-conductive wire, optical fiber, and so on.)

The term sensor module is used in general to describe a device that comprises at least one sensor that performs any actual sensing required, a processor that includes a communication module to send the information gathered by the sensor to a base unit, and all necessary hardware, software, power sources (e.g. a battery) and so on, to operate the sensor(s), the communication module, and so on. The sensor module may e.g. be partially or wholly encompassed within a housing, e.g. a molded plastic housing, which housing may be e.g. attached to or otherwise disposed on a connector or a D-ring. In some embodiments the sensor module may be attached e.g. to a safety line or a shroud thereon, or to a component (e.g. a strap or a dorsal plate) of a harness, as long as the sensor of the sensor module is positioned in a location that allows it to perform its desired function.

In some embodiments, a sensor of a sensor module may be configured to detect metal. This may be useful since many connectors (e.g. hooks/carabiners) and D-rings are made of metal such as steel or the like. Thus, a sensor located at a D-ring or docking station may be able to detect the presence of a metal connector; conversely, a sensor located at a connector may be able to detect the presence of a metal D-ring. In particular embodiments, any such sensor may be configured to particularly detect a metal item or a portion thereof that is positioned within, or close to, an opening defined by the entity at which the sensor is installed. For example, a connector (e.g. a gated hook) may be equipped with a sensor module whose sensor or sensors are configured to detect a portion of a metal item (e.g. a D-ring) that is within, or close to, the opening defined by the hook. Any such sensor, if installed on or near an entity that is itself made of metal, may be configured to compensate for such metal (i.e., the sensor may be configured to detect the presence of an additional metal item, above and beyond the metal that is already there).

In some embodiments such a sensor may rely on magnetic sensing. In some embodiments such a sensor may rely on inductive sensing. In some embodiments of this type, such a sensor may interrogate and monitor changes in a resonant frequency of an electronic circuit of an inductive sensor (which changes may result e.g. from eddy current phenomena that is generated when a metal item is brought into an inductive field). Inductive sensing in general, and leveraging of eddy current phenomena in particular, are discussed in detail in U.S. Provisional Patent Application No. 62/628,720, and the resulting PCT application published as WO2019/157007, both of which are incorporated by reference in their entirety herein. It will be appreciated that many of the principles, arrangements and methods disclosed in these documents may be useful for purposes of the present application.

Although discussions above have primarily concerned sensing of metal items, e.g. by inductive sensing, it will be appreciated that any sensor, relying on any sensing mechanism, may be used to sense whether an item is present in an opening defined by the hook. In various embodiments, such a sensor may be any kind of electromechanical sensor, e.g. a load cell that can detect whether the hook has been placed under load. In some embodiments, such a sensor may be an RFID or NFC reader that is configured to detect an RFID or NFC tag or beacon that is present on or in the item (e.g. a D-ring, a docking station, etc.) that the hook is to be connected to.

In some embodiments, at least one other sensor, operating by any sensing mechanism and provided in any particular location and/or applied to any particular step or operation in the use of connector 30 or of the fall-protection apparatus in general, may be used. Such a sensor may operate by some other mechanism than detecting whether an item is present in the opening defined by the hook. While in some embodiments such a sensor may be used in place of the above arrangements, in many advantageous embodiments such a sensor may be used in combination with the above-described arrangements. For example, in some embodiments a hook may be provided with a gate sensor that can monitor the status of a gate of the connector. Such a sensor may be used e.g. in combination with any of the other sensors described herein. For example, in some embodiments one or more first sensors may be used that are inductive sensors configured to determine whether a metal item (e.g. a metal D-ring) is present in the opening of the connector; and one or more second, gate sensors may be used to monitor the status of a gate of the connector.

Any such indication provided by a gate sensor will fall under the general category of reporting whether the gate is “secured” or “unsecured”. In some embodiments it may not be that, for example, a gate of a hook must actually be in an open position to be reported as “unsecured”. Rather, the gate may merely be e.g. unlocked. For example, a connector may be a double-action connector of the general type noted earlier, for example a “twist-lock” hook in which a locking mechanism of the gate of the hook must be rotated slightly in order to unlock the gate so that it can then be opened. A gate sensor may be configured to monitor that the gate is unsecured if it is detected that the locking mechanism has been rotated to the unlocked position, even if the gate has not actually been opened.

In some embodiments a second sensor or sensors such as e.g. a gate sensor, may operate by a different mechanism than the first sensor or sensors. For example, in some embodiments, a gate sensor may be a so-called Hall-effect sensor. In some embodiments such a sensor may be configured to detect the presence or absence (within a predetermined distance) of a magnetic beacon that is purposefully installed in the gate. For example, such a magnetic beacon (e.g. a piece of any suitably magnetic material) may be e.g. installed into a cavity provided in a twistable portion (e.g. a locking mechanism) of the gate. The gate sensor may detect the magnetic beacon, and report its presence, when the beacon is in close proximity (e.g. when the gate is secured). The sensor may then report the absence of the magnetic beacon when the twistable portion of the gate has been twisted to unlock the gate (thus moving the beacon away from the sensor). In some embodiments any such gate sensor may alternatively be configured (e.g. the sensor and magnetic beacon may be positioned) to detect the beacon when the gate is not secured, and to detect the absence of the beacon when the gate is secured.

As noted earlier, in many embodiments the output of a fall-protection monitoring system as disclosed herein will be at least a first positive signal, based on information received from at least one sensor or sensors. In some embodiments in which first and second sensors are used, a signal from the first sensor alone, or a signal from the second sensor alone, may not be sufficient to allow a first positive signal to be generated. That is, in some embodiments an appropriate signal must be received from both a first sensor and from a second sensor. Thus, for example, a monitoring system for a gated hook may be configured so that a signal must be received from a first sensor indicating that a metal item (e.g. a metal D-ring) is or has been detected in the opening of the hook; and, a signal must be received from a second sensor indicating that the gate of the hook is secure, in order for a first positive signal, indicating that the connector of the fall-protection apparatus appears to be connected to a harness of a user of the aerial lift, to be issued. The use of information from first and second sensors in combination is described in further detail e.g. in U.S. Provisional Patent Application No. 62/978,024 and in the resulting PCT application published as WO 2020/194121, both of which are incorporated by reference in their entirety herein.

In some embodiments a sensor module may be powered by an internal source, e.g. a battery. If the sensor module is located e.g. within a housing provided on a connector, then (depending on the size of the housing and the connector) the space available for a battery may be limited. In some such cases, the battery may need to take the form of one or more “coin” or “button” batteries rather than a conventional 12 Volt battery, in order to fit within the space available. In such embodiments, it can be advantageous to configure first and second sensors of the sensor module in a way that will maximize battery life without compromising the performance of the sensor module.

For example, in embodiments in which a first sensor is a magnetic induction sensor that detects whether a metal item such as a D-ring is present within an opening of a gated hook, and in which a second sensor is a gate sensor that is Hall-effect sensor that detects whether the gate of the connector is closed and/or secured, the first, inductive sensor may exhibit a power consumption (when active) that is greater than the power consumption of the second, Hall-effect sensor, by a factor of ten, one hundred, or even one thousand. (Since many such sensors may be e.g. pulsed, any such power consumption may be averaged over a suitable period, e.g. a few seconds.)

Accordingly, in some embodiments the processor that operates the sensors may be configured so that the first sensor is not activated until the second (gate) sensor has detected a change in status of the gate, e.g. has detected that the gate has become unsecured. The first sensor may then be activated e.g. for a selected period of time as long as the gate remains in a particular condition (e.g. unsecured), and optionally for an additional selected period of time after the gate has returned to another condition (e.g. has become secured). After this, the first sensor can be returned to an inactive state in which it consumes little or no power. In some embodiments, the sensor module may be configured to inactivate the first, inductive sensor after the first sensor has detected a metal item, rather than remaining active for the duration of the selected time period, in order to further conserve power.

When a change in status of the gate is again detected, the first sensor may again be activated. Otherwise, the first sensor may remain in the inactive, low-power-consumption state indefinitely. It will be appreciated that according to the disclosures herein, not only can first and second sensors be used in combination to evaluate the status of a connector (e.g. a “ready” state may not be indicated unless the second sensor indicates that the gate is secured, and the first sensor indicates that a metal item, e.g. a D-ring, is or has been detected within the connector opening since the closing of the gate), the sensors may be collectively configured for efficient power management. That is, a more energy-consumptive sensor need only be triggered to become active upon a suitable signal being received from a more energy-efficient sensor. Thus for example, a second, gate sensor may be constantly operated (e.g. interrogating the gate via the Hall effect, up to several times a second) with little power consumption, while a first, highly energy-consumptive inductive sensor may remain inactive until triggered by the processor to become active, in response to a change in gate status indicated by the second, gate sensor.

It will thus be appreciated that according to the disclosures herein, a base unit of a fall-protection monitoring system may continue to periodically send first positive signals to the control circuitry of the aerial lift (thus allowing the vertical-motion function of the aerial lift to remain enabled), as long as the base unit continues to receive information from the sensor module indicating that, according to the second, gate sensor, the gate of the gated hook continues to remain closed (and/or, the base unit does not receive information from the sensor module indicating that the gate has been opened). Of course, any change in the information received from the second, gate sensor may also trigger the first sensor to be activated and queried as well, with this additional information also taken into account, as discussed above.

In some embodiments, a sensor module of a fall-protection monitoring system may be configured with one or more sensors that are capable of detecting more than merely the presence or absence of an item or portion thereof. By way of a particular illustration, such a sensor, as present on a connector, may be able to do more than simply report a yes/no indication of whether or not the connector appears to be attached to a detectable (e.g. metal) D-ring. Rather, the sensor may be able to provide an indication of whether the connector appears to be attached to a D-ring or appears to be attached to some other detectable item (such as e.g. a metal component of a docking station). Additionally, such a sensor may be able to distinguish both of these from a situation in which the connector does not appear to be attached to any detectable item.

In some embodiments, such arrangements may be enhanced by equipping one or more designated items with an add-on entity that is purposefully configured to alter the inductive signature of the item in a predetermined manner. With particular regard to inductive sensing, certain materials (e.g. ferrites) may be particularly suitable for purposes of altering the inductive signature of a metal item. Such materials may be, for example, disposed in a shroud, a wrap, a molded item, or the like, to form an add-on entity which may be e.g. mounted on or otherwise disposed on or near the metal item whose inductive signature is desired to be modified. Multimodal sensing and arrangements made possible thereby, are discussed in detail in U.S. Provisional Patent Application 62/872,545 and in the resulting PCT patent application published as WO 2021/005467, both of which are incorporated by reference in their entirety herein.

Discussions so far have primarily focused on determining whether a connector appears to be connected to a harness of an operator of an aerial lift by a combination of sensing the presence/absence of an item (e.g. a D-ring) in an opening of a hook and sensing the secured/unsecured status of a gate of the hook. However, the general arrangements disclosed herein, in which an aerial lift is interlocked with a fall-protection apparatus by way of a fall-protection monitoring system, may be used with any sensing method or combination thereof. For example, a sensing system based on one or more cameras along with image-processing circuitry may be able to determine whether a connector of a fall-protection apparatus appears to be connected to a D-ring of a harness of an operator of the aerial lift versus e.g. hanging free from an SRL housing or docked in a docking station. By “camera” is meant any appropriate image-acquisition device; such a device is not necessarily limited to acquiring visual-wavelength light but rather could be configured e.g. to capture infrared radiation. Any suitable number of cameras may be used. In some embodiments, at least one such camera may be positioned generally rearward of the position at which the user stands on the operator-support platform of the aerial lift, so that the camera can get an unobstructed view of the dorsal D-ring of the operator's harness to determine whether the connector appears to be connected to the dorsal D-ring. Thus for example, a camera may be positioned at a rearward end of an overhead guard 9 of the aerial lift, aimed generally forward and downward toward the general location at which the dorsal D-ring is expected to be found during ordinary use of the aerial lift.

In some embodiments, such a camera-based sensing system may rely on markers (e.g. passive markers such as retroreflective indicia, or active markers in the form of LEDs) provided on one or both of the connector of the fall-protection apparatus and a D-ring of the user's harness. In other embodiments, a markerless system may be used. Any such sensing system will comprise image-processing circuitry that is configured to identify a connector, to identify a D-ring, and to ascertain whether the connector appears to be connected to the D-ring. Here and elsewhere, terminology such as “connected to a D-ring” encompasses situations in which a connector of a fall-protection apparatus is directly connected to the D-ring, and also encompasses situations in which the connector is connected to an item (e.g. an extender) that is itself connected to the D-ring (noting further that, as emphasized earlier herein, the term “D-ring” generically encompasses any suitable item that is attached to a user's harness so that a connector of a fall-protection apparatus can be connected thereto).

In some embodiments, such a camera-based sensing system may be used as an adjunct to, or as a replacement for, a sensor module of the general type described earlier herein (comprising one or more sensors located on the connector itself). It is thus emphasized that the general arrangements disclosed herein for monitoring whether a connector of a fall-protection apparatus appears to be connected to a harness of a user of an aerial lift, are not necessarily limited to any one sensing method or combination of sensing methods. It can also be appreciated that a fall-protection monitoring system as disclosed herein (e.g. comprising a camera-based sensing system) need not necessarily have any component that is mounted on, or directly connected to, the fall-protection apparatus that the monitoring system is used to monitor. Rather, in some embodiments some or all of the components of a monitoring system (e.g. a set of cameras and associated image-processing hardware) may be resident on the aerial lift rather than installed in or on the fall-protection apparatus itself.

In some embodiments, a camera-based sensing system may be configured to serve as an Operator Presence Control (OPC) switch of the general type described earlier herein. (This may be the case regardless of whether the camera-based sensing system also performs the above-described function of monitoring whether the connector of the fall-protection apparatus appears to be connected to the user's harness.) That is, one or more cameras and associated processing circuitry may be configured to ascertain whether a human user/operator is present on the operator-support platform of the aerial lift, whether the operator appears to be standing vertically, facing forward, etc. In other words, the sensing system may provide an indication of whether the operator appears to be in an attentive posture that indicates that the operator is in an appropriate condition for operating the aerial lift. Still further, the sensing system may include at least one camera that faces generally toward the operator's face and serves, in conjunction with associated circuitry to monitor whether the operator has his or her eyes open.

Beyond this, in some embodiments such a sensing system may comprise at least one thermal imaging camera (or, in general, an infrared sensor) that may provide an indication of whether the operator appears to be running a fever. In some embodiments such a sensing system may comprise motion-capture functionality and may be configured to provide an indication of whether the operator is moving (or not moving) in such a manner as to indicate that the operator may be impaired, suffering from a medical condition, and so on. Still further, in some embodiments such a sensing system may comprise at least one camera, and associated circuitry, that is configured to perform facial recognition in order to serve as an operator authentication apparatus. Such an authentication apparatus can be configured to identify a person that is standing on the operator-support platform and in particular to confirm that the person is trained and authorized to operate the aerial lift. The sensing system may thus cause a tertiary positive signal to be sent to the control circuitry of the order picker that allows the aerial lift to be operated. And, in some embodiments, such a sensing system may be configured to detect that two (or more) persons are present on the operator-support platform of an aerial lift, and to provide this information to the control circuitry of the aerial lift so that the aerial lift will accordingly enter a “multi-user” mode.

In a similar manner, a camera-based sensing system (or, in general, any sensing system, operating via any suitable mechanism) may be configured to ascertain whether any person (e.g. a single operator) is present on operator-support platform 2. In some embodiments, some of the functions described earlier herein may be put on standby or otherwise not carried out when an operator is not detected as being present. If an operator-sensing system is present, it may be used in combination with other systems for various purposes. For example, if an aerial lift is equipped to monitor its vertical elevation, and if an operator-sensing system reports that a user is no longer detected as being on the operator-support platform at a time at which the lift is elevated, the aerial lift (and/or the fall-protection monitoring system) may issue a notification of a possible fall event. In various embodiments, an operator-sensing system may rely e.g. on one or more infrared sensors, ultrasonic sensors, LIDAR sensors, and so on, instead of, or as an adjunct to, a camera-based sensing system.

In various embodiments, any of the above-described arrangements or combinations thereof may be employed, noting that in many embodiments some or all of the cameras of such a system will typically be resident on the aerial lift rather than on the fall-protection apparatus. Thus in various embodiments, an aerial lift may be provided with one or more camera-based sensing systems that perform any or all of the functions of an OPC switch, an operator authentication apparatus, and so on, regardless of whether the camera-based sensing system also serves as a fall-protection monitoring system.

As noted previously, in some embodiments a fall-protection monitoring system may perform an additional function of broadcasting one or more notifications. In some embodiments, this may be performed by a notification unit that is co-located with the base unit. In other embodiments, a notification unit can be provided that is separate from the base unit and is located e.g. on a vertical wall of the aerial lift (or in some other easily visible location) and that can be instructed by the base unit to broadcast a visible and/or and audible notification. That is, in some embodiments a notification unit may be separated from the base unit and may be present solely for the purpose of broadcasting a notification rather than comprising any other functionality. Any such notification unit can be configured (e.g. shaped and positioned) to ensure that it is easily visible but does not interfere with the vision of the operator of the order picker. Any such notification unit (comprising e.g. a string of LED lights) may be directly wired to the base unit, or the base unit may wirelessly operate the notification unit. It is not strictly necessary that an audible signal be broadcast from the same location as a visible signal; so, if desired, the monitoring system may comprise two physically separate notification systems, e.g. one audible and one visible.

Any such notification may be e.g. a Not Ready warning notification, meaning a notification that the connector of the safety apparatus does not appear to be connected to the user's harness. Or, it may be a Ready notification, meaning a notification that the connector does appear to be connected to the user's harness. Any such notification need not use specific words such as e.g. “Not Ready”; rather, a notification may take any suitable form whose meaning will be readily apparent to a trained user of the aerial lift and of the fall-protection system.

In some embodiments, the base unit may be configured to broadcast only a local notification (e.g. a visible signal and/or an audible signal). In some embodiments the base unit may be configured to provide a notification to a remote unit, e.g. to a smart phone or to a central station or hub at which the condition of numerous fall-protection systems and/or aerial lifts may be monitored. Such arrangements may make use of any desired communication method, protocol, or the like, including any of those mentioned below. Of course, in various embodiments, any of the conditions that are monitored by the herein-disclosed systems, may be e.g. logged, reported e.g. to a central hub or monitoring station for tracking purposes, and so on.

Any notification arrangement may be used in combination with any interlocking arrangement. For example, an order picker might be configured so that the order picker can be elevated e.g. up to 1 meter in the absence of a first positive signal indicating that the user's D-ring is connected to a connector of the fall-protection apparatus, but with the system issuing a notification when the order picker reaches e.g. 0.5 meter in height. In some embodiments, the system may issue increasingly strident warnings as the height limit is approached. As discussed in detail earlier herein, once the order picker reaches the predetermined height limit, the interlocking system will prevent the order picker from being elevated any higher until a first positive signal is received.

In some embodiments, a fall-protection system can optionally include a dedicated docking station to which connector 30 can be docked (i.e., connected) when not connected to the harness of a user of the aerial lift. In some embodiments a docking station can be a separate entity from base unit 60. In other embodiments a docking station can be integrated with base unit 60. In some embodiments a docking station may be a purely mechanical apparatus that does not participate, either actively or passively, in the fall-protection monitoring system. In other embodiments a docking station may be configured (e.g. equipped with a sensor module) to participate in the fall-protection monitoring system. That is, the presence of a docking station (whether integrated with base unit 60, or provided as a separate item at a separate location on the aerial lift) to which a connector 30 is to be docked, offers another possible way in which the condition of the connector may be monitored.

The base unit or units, the sensor module or modules, the control circuitry 17 of the aerial lift, and so on, can communicate in any desired manner. In many embodiments, communication between a base unit and a sensor module may conveniently be wireless, whether by e.g. wi-fi, a wireless local area network, Bluetooth, Zigbee, or any suitable method or protocol. In various embodiments, the communication between any such items may be two-way or one-way, as desired. For example in some embodiments a sensor module may wirelessly transmit to the base unit, but not vice versa. In such embodiments a sensor module may, for example, take sensor readings e.g. at a predetermined schedule and transmit the results to the base unit. In some embodiments, the base unit may, whether on a predetermined schedule or in response to an event, send an instruction to the sensor module to take a sensor reading and return the result to the base unit. The sensor module(s) and base unit(s) may be configured in the usual manner to perform an electronic handshake or the like, e.g. to ensure that (particularly in instances in which multiple aerial lifts operate in fairly close proximity) the base unit is communicating with the proper sensor module and vice versa.

Communications between the base unit and the control circuitry of the aerial lift may take any suitable form, e.g. wired or wireless, as noted previously herein; and, any such communication may be strictly one-way (base unit to control circuitry) or may be two-way, also as discussed previously herein. Although discussions herein have primarily concerned self-retracting lifelines, it will be understood that the arrangements and methods disclosed herein may be applicable to any fall-protection apparatus that is suitable for use with an aerial lift, e.g. an order picker. Such fall-protection apparatus may take the form of, for example, a safety line that is in the form of a lanyard that is not necessarily extendable from, and retractable into, a housing in the manner of an SRL. Some such lanyards may include products (often referred to as positioning lanyards) that provide fall-restraint rather than fall-arrest. It is thus emphasized that the arrangements and methods disclosed herein encompass fall-protection apparatus that provide fall-restraint, rather than being limited e.g. to only such fall-protection apparatus as provide fall-arrest. In some embodiments, a lanyard may include at least one energy absorber (e.g. a tear strip or the like) configured to dissipate the energy in the event of a fall; such lanyards are often referred to as energy-absorbing lanyards. The arrangements and methods disclosed herein are thus understood to be applicable, in various embodiments, to any such lanyards and to all such fall-protection apparatus in general.

Although discussions here have primarily concerned order pickers, it is understood that the arrangements and methods disclosed herein may be applicable to any aerial lift. An aerial lift can be any powered (e.g. motorized) apparatus that comprises an operator-support platform (whether open-sided, partially open-sided, or closed-sided) that can be moved at least in a generally vertical direction. In some embodiments (e.g. if the aerial lift is a cherry-picker or bucket truck) the platform may be movable in a horizontal direction and/or an angled direction rather than being limited to purely vertical movement. In many embodiments the entire aerial lift may be able to move horizontally; e.g. it may comprise a main body (e.g. a vehicle) that, in addition to supporting the vertically elevatable platform, is motorized and is steerable in a horizontal direction.

In various embodiments, an aerial lift with which a fall-protection apparatus and a fall-protection monitoring system as disclosed herein may be used, includes, in addition to the specific apparatus and categories already named, a so-called aerial work platform, a scissor lift, a reach truck (whether moving-carriage or moving-mast), a swing-reach truck, a turret truck, a motorized narrow-aisle truck (e.g. an OSHA Class II powered industrial truck), and so on. Some such lifts as conventionally available may not necessarily be equipped with an overhead-installed fall protection apparatus (e.g. a self-retracting lifeline (SRL)). However, if it is desired that an SRL be used with such an aerial lift, the lift can be specially modified (e.g. equipped with a vertical mast of any suitable height, on which the SRL can be mounted) to allow this, as long as such modification is in compliance with all applicable laws, rules, codes, standards, and so on.

The above discussions have made it clear that a fall-protection monitoring system as disclosed herein may be configured in multiple different ways. Some arrangements (e.g. in which a connector of a fall-protection apparatus is equipped with a sensor configured to detect a D-ring of a user's harness) may provide a “direct” indication that the connector appears to be attached to the D-ring and thus may provide a direct indication that the harness of an operator of an aerial lift appears to be connected to the safety line of the fall-protection apparatus. Other arrangements may provide a direct indication of some other status of the connector (e.g. an SRL housing may be equipped with a sensor that is able to provide a direct indication that the connector appears to be snugged against the SRL housing) and thus may provide an “indirect” indication that the connector does not appear to be connected to the operator's harness. It will thus be appreciated that the arrangements and methods disclosed herein may be used in a variety of ways and implementations, any of which may be used in combination.

It is emphasized that regardless of the functioning of any monitoring system of a fall-protection apparatus as disclosed herein, the user/operator of the aerial lift will be tasked with carrying out any appropriate steps (e.g. as required by applicable laws, rules, codes, standards, and/or instructions) e.g. to verify that the connector of the fall-protection apparatus is securely attached to the operator's harness. Under no circumstances will the presence of any arrangement as disclosed herein relieve an operator of an aerial lift of the duty to follow all appropriate laws; rules; codes; standards as promulgated by applicable bodies (e.g. ANSI); instructions as provided by the manufacturer of the aerial lift; instructions as provided by the manufacturer of the fall-protection system; instructions as provided by the entity in charge of a facility in which the aerial lift is used, and so on.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document that is incorporated by reference herein but to which no priority is claimed, this specification as written will control.

1. An aerial lift comprising:
a fall-protection apparatus installed on the aerial lift and comprising a safety line with a distal end comprising a connector configured to be connected to a safety harness worn by a user of the aerial lift, the aerial lift comprising a fall-protection monitoring system configured to determine whether the connector of the safety line appears to be connected to the safety harness of the user and the aerial lift comprising at least one additional safety apparatus in addition to the fall-protection apparatus:
wherein the aerial lift is interlocked with the fall-protection apparatus and with at the least one additional safety apparatus of the aerial lift so that in order for at least a vertical-motion function of the aerial lift to be enabled, control circuitry of the aerial lift must receive a first positive signal from the fall-protection monitoring system indicating that the connector of the safety line appears to be connected to the safety harness of the user; and, the control circuitry of the aerial lift must receive at least one additional positive signal from the at least one additional safety apparatus of the aerial lift indicating that the at least one additional safety apparatus is in a ready condition;
wherein the fall-protection monitoring system comprises a base unit and comprises at least one sensor module configured to sense whether the connector appears to be connected to the safety harness and to communicate connector status information to the base unit that is indicative of whether the connector appears to be connected to the safety harness;
and,
wherein the base unit is configured to receive the connector status information from the at least one sensor module and to send the at least one first positive signal to the control circuitry of the aerial lift if the connector status information received from the at least one sensor module indicates that the connector appears to be connected to the harness.

2. The aerial lift of claim 1 wherein the at least one additional safety apparatus comprises an operator presence control (OPC) switch that is configured so that when the OPC switch is in a condition indicative of active control of the aerial lift by the user of the lift, the OPC switch issues a primary additional positive signal indicating that the OPC switch is in a ready condition.

3. The aerial lift of claim 2 wherein the OPC switch comprises an upwardly-biased pedal provided on an operator-support platform of the aerial lift; and, wherein if the OPC switch is held in a downward position by a foot of the user of the aerial lift the OPC switch issues the primary additional positive signal indicating that the OPC switch is in the ready condition; and further wherein if the OPC switch is in an upward position the OPC switch does not issue the primary additional positive signal.

4. The aerial lift of claim 2 wherein the at least one additional safety apparatus of the aerial lift further comprises a safety gate apparatus comprising at least a first safety gate that is configured to be moved between a stowed position and a protective position;
wherein when the first safety gate is in its protective position it is disposed generally above a first lateral edge of the operator-support platform,
wherein the safety gate apparatus is configured to issue a secondary additional positive signal that the safety gate apparatus is in a ready condition when at least the first safety gate is in its protective position,
and wherein in order for at least the vertical-motion function of the aerial lift to be enabled, the first positive signal must be received from the fall-protection monitoring system, the primary additional positive signal must be received from the OPC switch, and the secondary additional positive signal must be received from the safety gate apparatus.

5. The aerial lift of claim 2 wherein the at least one additional safety apparatus of the aerial lift further comprises an operator authorization safety apparatus, and wherein in order for at least the vertical-motion function of the aerial lift to be enabled, the first positive signal must be received from the fall-protection monitoring system, the primary additional positive signal must be received from the OPC switch, and a tertiary additional positive signal must be received from the operator authorization safety apparatus.

6. (canceled)

7. The aerial lift of claim 1 wherein the fall-protection monitoring system is configured so if the fall-protection monitoring system determines that the connector of the safety line does not appear to be connected to the safety harness of the user, the fall-protection monitoring system will send a negative signal to the control circuitry of the aerial lift, whereupon the control circuitry of the aerial lift will disable at least the vertical-motion function of the aerial lift, and/or the aerial lift will issue at least one Not Ready warning notification that the connector of the safety line does not appear to be connected to the safety harness of the user.

8. The aerial lift of claim 1 wherein the fall-protection apparatus comprises a self-retracting lifeline (SRL) comprising a housing, with a proximal end of the safety line of the fall-protection apparatus being connected to a drum that is within the housing of the SRL and is rotatably connected to the housing of the SRL and with the safety line being extendable out of the housing and retractable into the housing: and, wherein the housing of the SRL is attached to an overhead panel of the aerial lift, the overhead panel of the aerial lift being positioned generally vertically overhead of an operator-support platform of the aerial lift.

9. (canceled)

10. The aerial lift of claim 1 wherein the fall-protection monitoring system is configured so that if the base unit of the fall-protection monitoring system receives the connector status information from the at least one sensor module indicating that the connector appears to be connected to the harness, the fall-protection monitoring system emits at least one Ready confirmation notification indicating that the connector appears to be connected to the harness, in addition to sending the first positive signal to the control circuitry of the aerial lift.

11. The aerial lift of claim 1 wherein the fall-protection monitoring system is configured so that if the base unit of the fall-protection monitoring system receives connector status information from the at least one sensor module indicating that the connector does not appear to be connected to the harness, the fall-protection monitoring system emits at least one Not Ready warning notification indicating that the connector does not appear to be connected to the harness.

12. The aerial lift of claim 1 wherein the base unit is disposed on or within a console of the aerial lift, the console being at least generally forward of an operator-support platform of the aerial lift.

13. The aerial lift of claim 1 wherein the control circuitry of the aerial lift is configured to receive the first positive signal from the base unit of the fall-protection monitoring system wirelessly.

14. The aerial lift of claim 1 wherein the control circuitry of the aerial lift is configured to receive the first positive signal from the base unit of the fall-protection monitoring system through a wired connection with the base unit.

15. The aerial lift of claim 1 wherein the control circuitry of the aerial lift and the base unit of the fall-protection monitoring system are configured so that communication that occurs between the control circuitry and the base unit is one-way communication of signals from the base unit of the fall-protection monitoring system to the control circuit of the aerial lift.

16. The aerial lift of claim 1 wherein the control circuitry of the aerial lift and the base unit of the fall-protection monitoring system are configured to provide two-way communication between the base unit of the fall-protection monitoring system and the control circuitry of the aerial lift.

17. The aerial lift of claim 16 wherein the fall-protection monitoring system and the control circuitry of the aerial lift are configured so that the control circuitry sends the fall-protection monitoring system information regarding the vertical elevation of the operator-support platform of the aerial lift; and,
wherein the fall-protection monitoring system is configured so that if the fall-protection monitoring system determines that the connector of the safety line appears to have become disconnected from the safety harness of the user while the aerial lift is in a vertically-elevated condition, the fall-protection monitoring system will issue an unhooked while elevated warning notification.

18. The aerial lift of claim 1 wherein the aerial lift is configured so that in the absence of the first positive signal from the fall-protection monitoring system and the at least one additional positive signal from the at least one additional safety apparatus, the aerial lift is substantially unable to elevate from a first, lowered position.

19. The aerial lift of claim 1 wherein the aerial lift is configured so that the aerial lift is unable to elevate from a first, lowered position beyond a predetermined height that is 4.0 feet or less in the absence of the first positive signal from the fall-protection monitoring system and the at least one additional positive signal from the at least one additional safety apparatus of the aerial lift; and, wherein the aerial lift is able to elevate beyond the predetermined height upon receipt of the first positive signal from the fall-protection monitoring system and the at least one additional positive signal from the at least one additional safety apparatus.

20. The aerial lift of claim 1 wherein the aerial lift comprises one or more manual control input devices that allow the user of the aerial lift to control vertical motion of the aerial lift; and,
wherein the control circuitry of the aerial lift is configured so that upon the first positive signal and the at least one additional positive signal being received by the control circuitry, the one or more manual control input devices that control the vertical motion of the aerial lift are activated to an active state so that they respond to inputs of the user of the aerial lift, and
wherein the control circuitry of the aerial lift is further configured so that if the first positive signal is not received and/or if the at least one additional positive signal is not received by the control circuitry, the one or more manual control input devices that control the vertical motion of the aerial lift are disabled so that they do not respond to inputs of the user of the aerial lift.

21-22. (canceled)

23. The aerial lift of claim 1, wherein the aerial lift is an order picker.

24. A method of controlling the operation of the aerial lift of claim 1, the method comprising:
maintaining the aerial lift in a condition in which at least the vertical-motion function of the aerial lift is disabled;
upon receiving the first positive signal from the fall-protection monitoring system and receiving the at least one additional positive signal from the at least one additional safety apparatus of the aerial lift, enabling at least the vertical-motion function of the aerial lift.

25. The aerial lift of claim 1 wherein the base unit is co-located with the at least one sensor module.

26. The aerial lift of claim 25 wherein the base unit and the at least one sensor module are co-located on or at the connector of the fall-protection apparatus.

27. The aerial lift of claim 1 wherein the base unit and the at least one sensor module are configured so that the at least one sensor module communicates the connector status information to the base unit that is indicative of whether the connector appears to be connected to the safety harness, by way of a wired connection.

28. The aerial lift of claim 1 wherein the base unit and the at least one sensor module are configured so that the sensor module communicates the connector status information to the base unit that is indicative of whether the connector appears to be connected to the safety harness, wirelessly.

29. The aerial lift of claim 1 wherein the connector status information that is communicated from the at least one sensor module to the base unit and that is indicative of whether the connector appears to be connected to the safety harness, comprises raw, unprocessed data that, after being received by the base unit, is processed at least in part by the base unit.

30. The aerial lift of claim 1 wherein the connector status information that is communicated from the at least one sensor module to the base unit and that is indicative of whether the connector appears to be connected to the safety harness, comprises data that is at processed at least in part by circuitry that is resident within the at least one sensor module.
